(19) United States
(12) Patent Application Publication
(10) Pub. No.: US 2024/0144100 A1
(43) Pub. Date: May 2, 2024

(54) METHOD, APPARATUS, DEVICE AND MEDIUM FOR TRAINING CONTRASTIVE LEARNING MODEL

(71) Applicant: Beijing Youzhuju Network Technology Co., Ltd., Pinggu District, Beijing (CN)

(72) Inventors: Hao Wu, Beijing (CN); Boyan Zhou, Beijing (CN); Quan Cui, Beijing (CN); Cheng Yang, Beijing (CN)

(21) Appl. No.: 18/496,769

(22) Filed: Oct. 27, 2023

(30) Foreign Application Priority Data
Oct. 31, 2022 (CN) 202211351695.9

(51) Int. Cl. G06N 20/00

(52) U.S. Cl. CPC G06N 20/00

(57) ABSTRACT

Methods, apparatuses, a device, and a medium for training a contrastive learning model are provided. In a method, a plurality of sample sets for training the contrastive learning model are obtained, and the plurality of sample sets comprises a first sample set and a second sample set. A first target sample set is selected from the first sample set and the second sample set according to a predetermined rule. A first set of samples are determined based on the first target sample set according to a predefined batch size. The contrastive learning model is trained using the first set of samples. In this way, on the one hand, performance degradation of the contrastive learning model due to sample set bias may be avoided; on the other hand, a forgetting problem in the training process may be alleviated.

### CROSS REFERENCE TO RELATED APPLICATIONS

The present application claims priority to Chinese Patent Application No. 202211351695.9, titled “METHOD, APPARATUS, DEVICE AND MEDIUM FOR TRAINING CONTRASTIVE LEARNING MODEL,” filed on Oct. 31, 2022, the contents of which are hereby incorporated by reference in its entirety.

### FIELD

Implementations of the present disclosure generally relate to machine learning, and in particular to methods, apparatuses, a device, and a computer-readable storage medium for training a contrastive learning model.

### BACKGROUND

With the development of machine learning technology, machine learning models can already be used to perform tasks in various application environments. In order to improve performance of a model, a technical solution has been proposed to train the model iteratively using multiple batches of training samples. For various reasons, it is difficult to obtain a sample set that includes a large number of training samples at once, and training samples usually come from different sample sets. Due to bias between sample sets and differences in the sequence of usage of sample sets, machine learning models usually cannot sufficiently learn semantic knowledge contained in training samples of respective sample sets. At this point, how to train a machine learning model using multiple sample sets in a more effective way has become an urgent problem to be solved.

### SUMMARY

In a first aspect of the present disclosure, a method for training a contrastive learning model is provided. In the method, a plurality of sample sets are obtained for training the contrastive learning model, the plurality of sample sets comprising a first sample set and a second sample set. A first target sample set is selected from the first sample set and the second sample set according to a predetermined rule. A first set of samples are determined based on the first target sample set according to a predefined batch size; and training the contrastive learning model using the first set of samples.

In a second aspect of the present disclosure, an apparatus for training a contrastive learning model is provided. The apparatus comprises an obtaining module, configured to obtain a plurality of sample sets for training the contrastive learning model, the plurality of sample sets comprising a first sample set and a second sample set; a selecting module, configured to select a first target sample set from the first sample set and the second sample set; a determining module, configured to determine a first set of samples based on the first target sample set according to a predefined batch size; and a training module, configured to train the contrastive learning model using the first set of samples.

In a third aspect of the present disclosure, an electronic device is provided. The device comprises at least one processing unit; and at least one memory coupled to the at least one processing unit and storing instructions executable by the at least one processing unit, the instructions, when executed by the at least one processing unit, causing the device to perform the method of the first aspect.

In a fourth aspect of the present disclosure, a computer-readable storage medium is provided. The medium has a computer program stored thereon which, when executed by a processor, performs the method according to the first aspect.

In a fifth aspect of the present disclosure, a method for data processing is provided. The method comprises training the contrastive learning model using the method according to the first aspect; and determining, using the trained contrastive learning model, an association relationship between data in a sample to be processed.

In a sixth aspect of the present disclosure, an apparatus for training a contrastive learning model is provided. The apparatus comprises a training module, configured to train the contrastive learning model using the apparatus according to the second aspect; and a determining module, configured to determine, using the trained contrastive learning model, an association relationship between data in a sample to be processed.

It would be appreciated that the content described in the Summary section of the present invention is neither intended to identify key or essential features of the implementations of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the implementations of the present disclosure will become more apparent in combination with the accompanying drawings and with reference to the following detailed description. In the drawings, the same or similar reference symbols refer to the same or similar elements, where:

FIG. 1 shows a schematic diagram of an example environment in which the implementations of the present disclosure can be implemented;

FIG. 2 shows a block diagram of a process of training a contrastive learning model using multiple sample sets according to some implementations of the present disclosure;

FIG. 3 shows a block diagram of a process for training a contrastive learning model according to some implementations of the present disclosure;

FIG. 4 shows a block diagram of a structure of a contrastive learning model according to some implementations of the present disclosure;

FIG. 5 shows a block diagram of a process for selecting a target sample set from multiple sample sets according to some implementations of the present disclosure;

FIG. 6 shows a block diagram of training samples in a sample set according to some implementations of the present disclosure;

FIG. 7 shows a block diagram of a process for generating negative samples according to some implementations of the present disclosure;

FIG. 8 shows a block diagram of training samples in another sample set according to some implementations of the present disclosure;

FIG. 9 shows a block diagram of comparisons of feature distribution according to some implementations of the present disclosure;

FIG. 10 shows a block diagram of comparisons of gradient indices of a loss function according to some implementations of the present disclosure;

FIG. 11 shows a flowchart of a method for training a contrastive learning model according to some implementations of the present disclosure;

FIG. 12 shows a block diagram of an apparatus for training a contrastive learning model according to some implementations of the present disclosure; and

FIG. 13 illustrates an electronic device in which one or more implementations of the present disclosure may be implemented.

### DETAILED DESCRIPTION

The implementations of the present disclosure will be described in more detail below with reference to the accompanying drawings. Although some implementations of the present disclosure are shown in the drawings, it would be appreciated that the present disclosure may be implemented in various forms and should not be interpreted as limited to the implementations described herein. On the contrary, these implementations are provided for a more thorough and complete understanding of the present disclosure. It would be appreciated that the drawings and implementations of the present disclosure are only for illustrative purposes and are not intended to limit the scope of protection of the present disclosure.

In the description of the implementations of the present disclosure, the term “including” and similar terms should be understood as open inclusion, that is, “including but not limited to”. The term “based on” should be understood as “at least partially based on”. The term “one implementation” or “the implementation” should be understood as “at least one implementation”. The term “some implementations” should be understood as “at least some implementations”. Other explicit and implicit definitions may also be included below.

It is understandable that the data involved in this technical proposal (including but not limited to the data itself, data acquisition or use) shall comply with the requirements of corresponding laws, regulations, and relevant provisions.

It is understandable that before using the technical solution disclosed in each implementation of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server, or a storage medium that perform the operation of the technical solution of the present disclosure according to the prompt information.

As an optional but non-restrictive implementation method, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It may be understood that the above notification and acquisition of user authorization process are only schematic and do not limit the implementation methods of the present disclosure. Other methods that meet relevant laws and regulations may also be applied to the implementation of the present disclosure.

The term “in response to” used here refers to a state in which a corresponding event occurs or a condition is met. It will be understood that there may not be a strong correlation between the execution timing of a subsequent action executed in response to the event or the condition and the time when the event occurs or the condition meets. For example, in some cases, the subsequent action may be executed immediately when the event occurs or the condition meets; in other cases, the subsequent action may only be performed after a period of time after the event occurs or the condition meets.

### Sample Environment

FIG. 1 shows a block diagram of an example environment 100 in which the implementations of the present disclosure can be implemented. In the environment 100 of FIG. 1, it is expected to train and use such a machine learning model (for example, a model 130), which is configured for various application environments, for example, for identifying an image content, and so on. As shown in FIG. 1, the environment 100 includes a model training system 150 and a model application system 152. The upper part of FIG. 1 shows a process of a model training stage, and the lower part shows a process of a model application stage. Before the training, parameter values of the model 130 may have initial values or have pre-trained parameter values obtained through a pre-training process. The model 130 may be trained through forward propagation and backward propagation, and the parameter values of the model 130 may be updated and adjusted during the training process. After the training is completed, a model 130′ may be obtained. At this point, parameter values of the model 130′ have been updated, and based on the updated parameter values, the model 130 may be used to implement a prediction task during the model application stage.

In the model training stage, the model 130 may be trained based on a training sample set 110 that includes multiple samples 112 and using the model training system 150. Here, each sample 112 may involve a 2-tuple format and include data 120 and a label 122 related to a task to be processed. At this point, the sample 112 including the data 120 and the label 122 may be used to train the model 130. Specifically, a large number of training samples may be utilized to perform the training process iteratively. After the training is completed, the model 130 may include knowledge related to the task to be processed. In the model application stage, the model application system 152 may be used to call the model 130′ (at this point, the model 130′ has trained parameter values). For example, input data 140 (including data to be processed 142) may be received and a corresponding answer of the task to be processed (that is, a label 144) may be output.

In FIG. 1, the model training system 150 and the model application system 152 may include any computing system with computing capabilities, for example, various computing devices/systems, terminal devices, servers, or the like. The terminal devices may involve any type of mobile terminal, fixed terminal or portable terminal, including a mobile phone, a desktop computer, a laptop computer, a notebook computer, a netbook computer, a tablet computer, a media computer, a multimedia tablet, or any combination thereof, including an accessory and a peripheral of these devices or any combination thereof. The servers include but are not limited to a mainframe, an edge computing node, a computing device in a cloud environment, and/or the like.

It should be understood that the components and the arrangements shown in the environment 100 in FIG. 1 are only examples, and a computing system suitable for implementing the example implementations described in the present disclosure may include one or more different components, other components, and/or different arrangements. For example, although shown as separate, the model training system 150 and the model application system 152 may be integrated into a same system or device. The implementations of the present disclosure are not limited in this regard. The example implementations for model training and model application will be described in the following respectively with reference to the accompanying drawings.

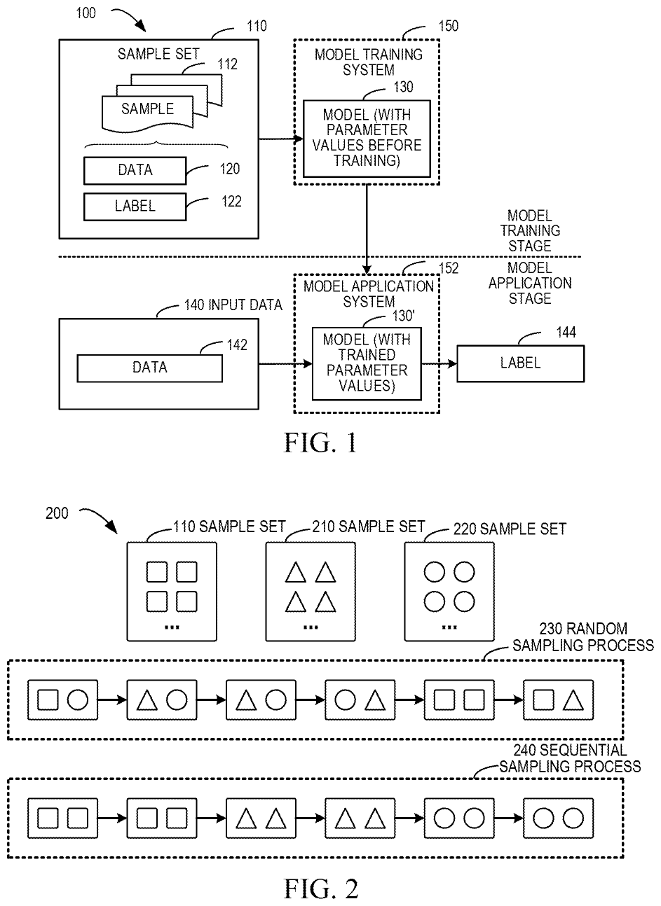

It will be understood that for various reasons, it is difficult to obtain the sample set 110 that includes sufficient training samples at once. In addition, introducing training samples from more data sources may improve performance of the model 130 significantly, therefore multiple sample sets may be usually introduced in practical applications. Currently, a technical solution has been proposed to perform training using training samples from multiple sample sets, for example, the training may be performed based on a random sampling process or a sequential sampling process. More details on the training process are described with reference to FIG. 2, which shows a block diagram 200 of a process of training a contrastive learning model using multiple sample sets according to some implementations of the present disclosure.

In FIG. 2, there may be multiple sample sets 110, 210, 220 and the like. At this point, each sample set may include training samples obtained from different data sources. Specifically, samples in different sample sets may be represented in different shapes, for example, samples in the sample set 110 are shown in boxes, samples in the sample set 210 are shown in triangles, and samples in the sample set 220 are shown in circles. Samples in each batch may be determined according to a predetermined batch size (for example, n=1024 or other numerical values).

In a random sampling process 230, n samples may be randomly selected from three sample sets 110, 210, and 220, and the model 130 may be trained in multiple batches iteratively to obtain the trained model 130′. Although the random sampling process 230 may be suitable for conventional models, there may be a problem of sample set bias in contrastive learning scenarios. Specifically, quality of negative samples in contrastive learning determines performance of encoders in the model. Sample set bias leads to oversimplification of negative samples, and makes it easy for models to distinguish between positive and negative samples, resulting in insufficient training and poor encoder performance.

In a sequential sampling process 240, training samples may be selected from each sample set in sequence. That is to say, the samples in the sample set 110 are used to perform training firstly, then the samples in the sample set 210 are used to perform training, and after that the samples in the sample set 220 are used to perform training. At this point, performance of a downstream model depends on sample sets that are used later. That is, the closer the data distribution between the sample set that is used at last and a downstream test set, the better the performance. The reason for this phenomenon is that early training samples will be “forgotten” gradually over time and covered by relevant gradients of sample set used later. At this point, it is expected to train the contrastive learning model in a more effective way.

### Summary Process of Training a Contrastive Learning Model

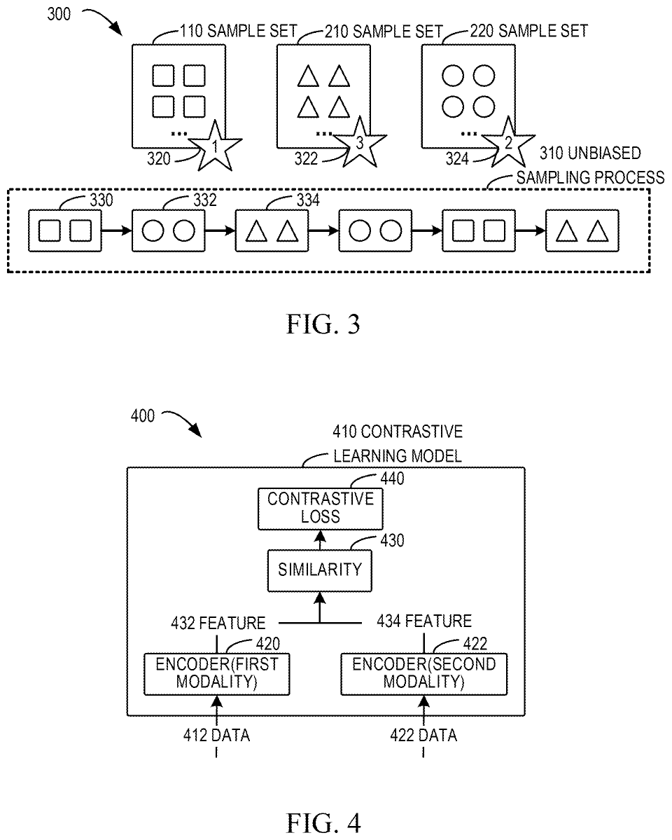

In order to at least partially address the aforementioned shortcomings, a training method based on unbiased sampling process is proposed to train a contrastive learning model based on multiple sample sets. A summary of an example implementation according to the present disclosure is described with reference to FIG. 3, which illustrates a block diagram 300 of a process for training a contrastive learning model according to some implementations of the present disclosure. As shown in FIG. 3, multiple sample sets 110, 210, and 220 may be obtained for training the contrastive learning model. It will be understood that although FIG. 3 shows specific examples of three sample sets, in the context of the present disclosure, multiple sample sets include at least two different sample sets, that is, a first sample set and a second sample set.

In a batch-based training process, a target sample set may be selected from a plurality of sample sets according to a predetermined rule (for example, random, polling, or based on a sample amount in respective sample sets). Subsequently, training samples to be used in that batch may be determined from the target sample set according to a predefined batch size. Specifically, in a proposed unbiased sampling process 310, as shown by a label 320, the sample set 110 may be used as the target sample set in a first batch (a batch 330), and n training samples in the batch 330 may be selected from the sample set 110. As shown by a label 322, the sample set 210 may be used as the target sample set in a second batch (a batch 332), and n training samples in the batch 332 may be selected from the sample set 210. As shown by a label 324, the sample set 220 may be used as the target sample set in a third batch (a batch 334), and n training samples in the batch 334 may be selected from the sample set 220.

The training process may be performed using training samples of multiple batches in multiple batches. Furthermore, the aforementioned processes may be repeated continuously, and the training process ends when the model reaches convergence and/or all data in respective sample sets has been used for training.

By using example implementations disclosed in the present disclosure, no problem of sample set bias exists during the training process of respective batches as the training samples in each batch are from the same sample set. Therefore, semantic knowledge in the training samples may be obtained sufficiently during the training process of each batch. Furthermore, because the target sample set is selected in each batch in an independent manner, the target sample set selected in each batch will have difference, and data in each sample set will alternately work as the training sample. In this way, the forgetting problem in the sequential sampling scheme may be avoided.

### Detailed Process of Training a Contrastive Learning Model

The summary process of training the contrastive learning model has already been provided above, and more detailed information related to the training process will be provided in the following. According to an example implementation of the present disclosure, samples in respective sample sets may include data of different modalities. Specifically, each sample may include data of a first modality (for example, an image), data of a second modality (for example, text), and a label representing an association relationship between the data of the first modality and the data of the second modality.

In the context of the present disclosure, a machine learning model for processing an association relationship between images and text will be used as an example of the contrastive learning model to describe more information about the training process. The contrastive learning model here may describe whether the content of an image and text are consistent. For example, if both the image and the text involve “a horse eats grass”, the content of the image and the text are consistent. If the image involves “a horse eats grass” but the text involves “a cattle eats grass”, the content of the image and the text is inconsistent. A structure of the contrastive learning model is described with reference to FIG. 4, which shows a block diagram 400 of the structure of a contrastive learning model 410 according to some implementations of the present disclosure.

As shown in FIG. 4, the contrastive learning model 410 may include an encoder 420 of the first modality and an encoder 422 of the second modality. Specifically, the encoder 420 may describe an association relationship between image data and a feature of the image data, and the encoder 422 may describe an association relationship between text data and a feature of the text data.

The encoder 420 may process input data 412 in an image format and output a corresponding feature 432. The encoder 422 may process input data 422 in a text format and output a corresponding feature 434. The similarity 430 may be determined based on a difference between two features 432 and 434, and corresponding contrastive loss 440 may be determined. Furthermore, during the training process, the contrastive learning model 410 may be updated continuously based on the contrastive loss 440.

Here, the encoders 420 and 422 may have initial parameters and/or pre-trained partially optimized parameters. The encoders 420 and 422 may be optimized continuously during the training process of the contrastive learning model 410, so that the contrastive learning model 410 may recognize the similarity between the input image and text. In this way, training samples of respective batches may be utilized continuously to perform optimization in multiple stages, thereby improving the performance of the contrastive learning model 410.

According to an example implementation of the present disclosure, the target sample set may be selected based on a predetermined rule. The predetermined rule here may include any of: a random selection rule, a polling selection rule, and a selection rule based on a sample amount. The random selection rule may specify that a sample set is selected from multiple sample sets randomly in each batch. Because the sample set in each batch is selected randomly, the forgetting problem during sequential sampling may be avoided. Alternatively, and/or in addition, the polling selection rule may specify that each sample set is selected one by one in sequence. In this way, the sample sets selected twice before and after are different, which may also avoid the forgetting problem in the sequential sampling process.

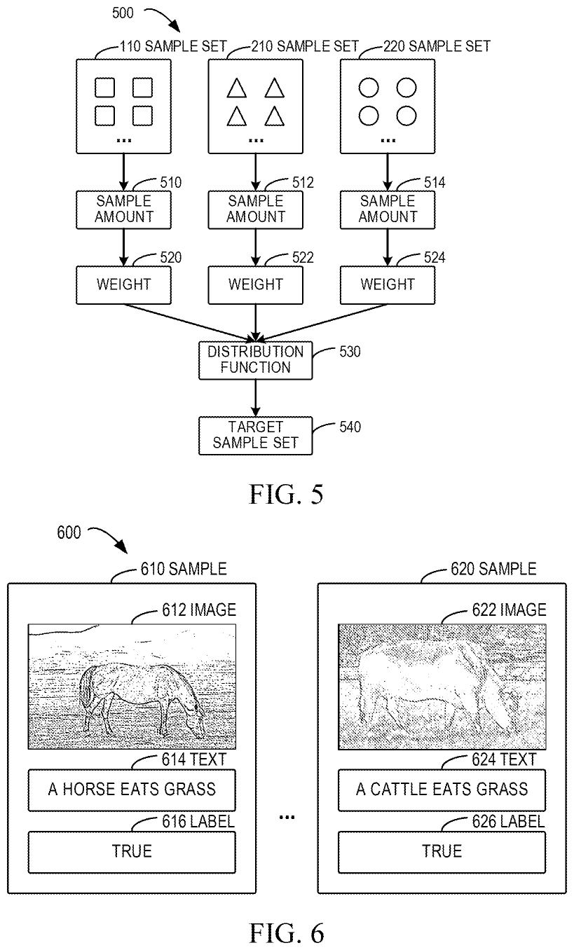

According to an example implementation of the present disclosure, in order to avoid a problem of insufficient use of samples in respective sample sets, the selection rule based on the sample amount may be used. Specifically, multiple sample sets 110, 210, and 220 (for example, represented as D₁, D₂, and D₃, respectively) for training the contrastive learning model 410 may be obtained separately. Further, the target sample set for the current batch may be selected from multiple sample sets. FIG. 5 shows a block diagram 500 of a process for selecting a target sample set from multiple sample sets according to some implementations of the present disclosure. As shown in FIG. 5, the amount of training samples in respective sample sets may be determined respectively. For example, a sample amount 510 in the sample set 110, a sample amount 512 in the sample set 210, and a sample amount 514 in the sample set 220 may be determined.

Specifically, the sample amounts 510, 512, and 514 of the three sample sets may be represented as I|D₁|, |D₂|, |D₃| respectively, and weights of respective sample sets may be determined based on the above amounts. For example, the weights may be determined based on the following Equation 1:

$${w}_{i} = \frac{\vert {D}_{i} \vert}{{\sum }_{j = 1}^{M} \vert {D}_{j} \vert} \qquad Equation 1$$

In Equation 1, wᵢ represents a weight of an i^{th} dataset, |Dᵢ| represents a sample amount in the i^{th} dataset, and M represents a total number of multiple sample sets. Equation 1 may be used to determine weights 520, 522, and 524 of respective sample sets. In other words, corresponding weights may be determined based on the proportion of the sample amount of respective sample sets to the total samples, thereby the process of determining weights may be transformed into a simple mathematical operation.

Furthermore, the determined weights may be used to select the target sample set. Specifically, a distribution function 530 may be predefined, and the determined weights 520, 522, and 524 may be input to the distribution function 530, thereby determining a target sample set 540 in the current batch. According to an example implementation of the present disclosure, an index of the target sample set 540 may be determined based on a polynomial distribution function. For example, the index of the target sample set 540 may be determined based on the following Equation 2:

γ=f(w₁, w₂, . . . , w_{M}) Equation 2

In Equation 2, γ represents the index of the target sample set to be selected in the current batch, ƒ( )represents the polynomial distribution function, and w₁, w₂, . . . , w_{M} represents the weights of respective sample sets. It will be understood that the respective symbols in Equation 2 have the same meaning as the symbols in the aforementioned Equation 1, and therefore will not be repeated. According to an example implementation in the present disclosure, ƒ( )may be defined based on probability distribution. Assuming that the weights of respective sample sets are 20%, 40%, and 40% respectively, then the sample sets 110, 210, and 220 may be selected with probabilities of 20%, 40%, and 40% in each batch. By utilizing the example implementations of the present disclosure, the target sample set may be selected based on a simple and effective way, and full utilization of the training samples in respective sample sets may be ensured.

According to an example implementation of the present disclosure, in a case where the target sample set 540 of each batch has been determined, respective samples used for the training of the current batch may be determined from the target sample set 540. FIG. 6 shows a block diagram 600 of training samples in a sample set (for example, the sample set 110) according to some implementations of the present disclosure. As shown in FIG. 6, there may be multiple training samples 610, . . . , and 620. The training sample 610 may include an image 612 (that is, the data of the first modality), text 614 (that is, the data of the second modality), and a label 616 representing the association relationship between the data of the first modality and the data of the second modality. Because the content of the image 612 and the text 614 are consistent (both involving “a horse eats grass”), then the label 616 is “true” at this time.

Furthermore, the training sample 620 may include an image 622, text 624, and a label 626 that describes the content consistency between the image 622 and the text 624. Because the content consistency between the image 622 and the text 624 are consistent (both involving “a cattle eats grass”), the label 626 is also “true” at this time. In the context of the present disclosure, training samples labeled as true may be referred to as positive samples. Although FIG. 6 only shows positive samples, negative samples may also exist. For example, if a certain sample includes the image 612 and the text 624, then the content of the image and the text are inconsistent. The label of this training sample is “false” and the training sample may be referred to as a negative sample.

It will be understood that although an example where the first modality is an image and the second modality is text has been described above, alternatively and/or in addition, the first modality and the second modality may be interchanged. Alternatively, and/or in addition, the first modality and the second modality may also involve the same data format, for example, in an image processing (for example, cropping, flipping, and the like) environment, both modalities may involve images. According to an example implementation of the present disclosure, the first modality and the second modality may also involve other formats which includes but are not limited to images, text, video, audio, and the like.

According to an example implementation of the present disclosure, assuming that the target sample set 540 in the first batch is the sample set 110, a positive sample may be selected from the sample set 110 and the positive sample may be added to a first group of samples for performing the training process of the first batch. In an initial stage, the first group of samples may be empty, and the sample 610 may be selected and added to the first group of samples. At this point, the first group of samples include the sample 610.

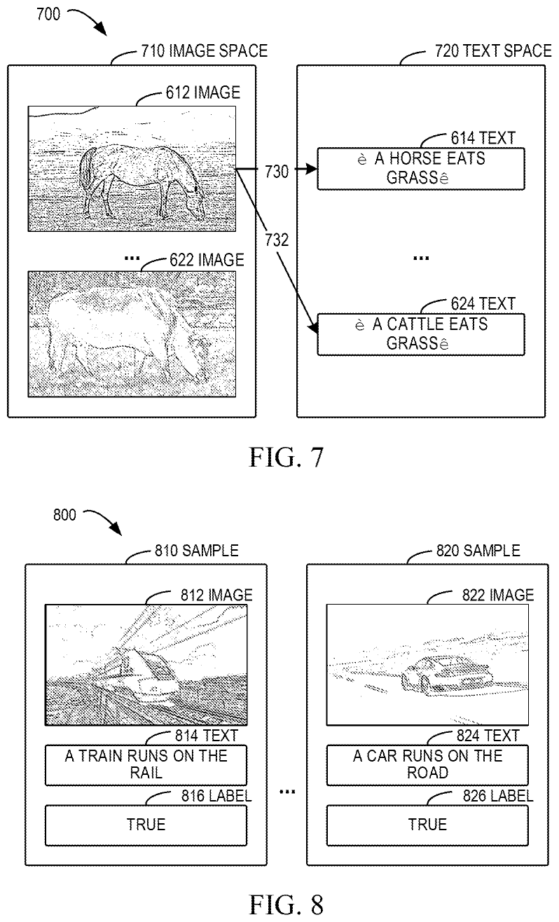

It will be understood that providing more negative sample data in contrastive learning helps to gain more knowledge from the contrastive learning model 410. Therefore, more negative samples may be constructed based on the obtained positive samples to improve the efficiency of the training process. According to an example implementation of the present disclosure, negative samples may be generated based on image data in positive samples and other text data in the sample set 110. More details on selecting samples is described with reference to FIG. 7 which illustrates a block diagram 700 of a process for generating negative samples according to some implementations of the present disclosure.

As shown in FIG. 7, an image space 710 where image data is located in may be determined, which may include respective images from the sample set 110, for example, the images 612, . . . , and 622. Furthermore, a text space 720 where text data is located in may be determined, which may include respective text from the sample set 110, for example, the text 614, . . . , and 624. According to an example implementation of the present disclosure, the image in the image space 710 may be combined with the text in the text space 720, and a corresponding label may be determined based on the content consistency of the image and the text.

Specifically, the data in the first modality (for example, the image 612 in the image space 710) may be combined with the data in the second modality (for example, the text 614, . . . , and 624 in the text space 720) to generate positive samples or negative samples. As shown by an arrow 730 in FIG. 7, the image 612 and the text 614 may be combined, at this time, the label is “true”, and a positive sample is generated. According to an example implementation of the present disclosure, when combining the image 612 with text other than the text 614, a negative sample may be generated. As shown by an arrow 732, the image 612 may be combined with the text 624, at this time, the label is “false”, and a negative sample is generated.

It will be understood that although the process of generating corresponding positive and negative samples for the given image 412 is described above, alternatively and/or in addition, the first modality and the second modality may be interchanged. In other words, a certain text (for example, the text 614) may be specified and the text 614 may be combined with respective images in the image space 710 respectively to generate corresponding positive and negative samples.

Assuming that the image space 710 includes u images and the text space 720 includes v text, then 1 positive sample and v−1 negative samples may be determined for each of the u images. Furthermore, all v samples may be used as the first batch of training samples for training the contrastive learning model 410. In this way, the number of training samples in each batch may be greatly increased, thereby improving the accuracy of the contrastive learning model 410.

According to an example implementation of the present disclosure, the contrastive learning model 410 may be trained in each batch based on various methods that are currently known and/or to be developed in the future. Firstly, the process of processing a positive sample is described. The encoders 420 and 422 of the contrastive learning model 410 may be used to determine an image feature of the image data and a text feature of the text data in the positive sample, respectively. Further, a loss function of the contrastive learning model 410 may be determined based on a difference between the image feature and the text feature. It will be understood that in contrast learning, the distance between relevant features of two data in the positive sample is expected to be shortened, so that respective parameters of the contrastive learning model 410 may be updated in a direction that causes the loss function to reduce. In this way, the contrastive learning model may be trained in a way that is more conducive to identifying the similarity between an image and text.

According to an example implementation of the present disclosure, a negative sample may be processed in a similar manner. Specifically, the encoders 420 and 422 of the contrastive learning model 410 may be used to determine an image feature of the image data and a text feature of the text data in the negative sample, respectively. Further, the loss function of the contrastive learning model 410 may be determined based on the difference between the image feature and the text feature. It will be understood that in contrastive learning, the distance between relevant features of two data in the negative sample is expected to be pushed farther, so that respective parameters in the contrastive learning model may be updated in a direction that causes the loss function to increase. In this way, the contrastive learning model may be trained in a way that is more conducive to distinguishing differences between an image and text.

The training process of a single batch has been described above, and according to an example implementation of the present disclosure, the training process of other batches may be performed in a similar manner. Returning to FIG. 3, after the training process of the first batch 330, the target sample set of the second batch 332 may be determined based on the aforementioned Equation 1 and Equation 2. Assuming that the sample set 220 is determined to be the target sample set for the batch 332, then the sample set 220 may be used to determine the corresponding positive and negative samples, thereby performing the training process for the second batch.

According to an example implementation of the present disclosure, the process of selecting the target sample set in respective batches may be independent, and target sample sets in the former and latter batches may be different. For example, the aforementioned predetermined rule may be performed independently and the target sample set for each batch may be selected independently. In other words, the target sample set selected in subsequent batches is independent of the target sample set selected in the previous batch. This is different from the process of selecting sample sets one by one in sequential sampling, and a next sample set is selected after using up training samples in the current sample set.

FIG. 8 shows a block diagram 800 of training samples in a further sample set according to some implementations of the present disclosure. Assuming that the sample set 220 includes samples 810, . . . , and 820, positive samples may be selected from the sample set 220, and other text data different from text data of the positive samples may be selected from the text space of the sample set 220 to create multiple negative samples. Furthermore, the contrastive learning model 410 may be trained based on the selected positive samples and multiple created negative samples.

As shown in FIG. 8, the sample 810 may include an image 812, text 814, and a label 816, . . . , a sample 820 may include an image 822, text 824, and a label 826. At this point, the image 812 and the text 814 may be combined as a positive sample, and the image 812 and the text 824 may be combined as a negative sample. In this way, corresponding negative samples may be created using positive samples of respective sample sets continuously in subsequent batches, and the contrastive learning model may be trained using the positive and negative samples.

It will be understood that in the training process of each batch, positive samples that have already been used in respective sample sets may be labeled, and when a certain sample set is used subsequently, positive samples that have already been used will no longer be selected. For example, it is assumed that the sample 610 of the sample set 110 has already been used in the first batch, then when positive samples are selected from the sample set 110 subsequently, positive samples may be selected from samples other than the sample 610. For example, the sample 620 of the sample set 110 may be selected as a positive sample. In this way, the occurrence of duplicate training samples may be avoided, and all training samples of respective sample sets may be utilized more sufficiently.

It will be understood that bias of the sample set is harmful to the downstream model, and may even be detrimental to semantics of the contrastive learning model itself. To address a problem of sample set bias, it is specified that each batch of training samples should come from a single sample set, which eliminates influence of the sample set bias and makes the contrastive learning model pay more attention to useful semantic knowledge within a single sample set in the training process of each batch, rather than the sample set bias.

By utilizing the example implementations of the present disclosure, the problem of bias between multiple sample sets may be overcome, thereby improving the performance of the contrastive learning model 410. It will be understood that bias between sample sets may lead to occurrence of bias in the feature distribution of respective samples, thereby making it difficult for the features to accurately distinguish respective samples. In the following, performance of the proposed training method will be verified by multiple publicly available sample sets. For example, a Visual Genome (VG) sample set, an SBU sample set, a CC3M sample set, and a CC12M sample set may be selected as multiple sample sets of the present disclosure. Due to sample bias between respective sample sets, the feature distribution obtained through training based on conventional random sampling processes is not uniform.

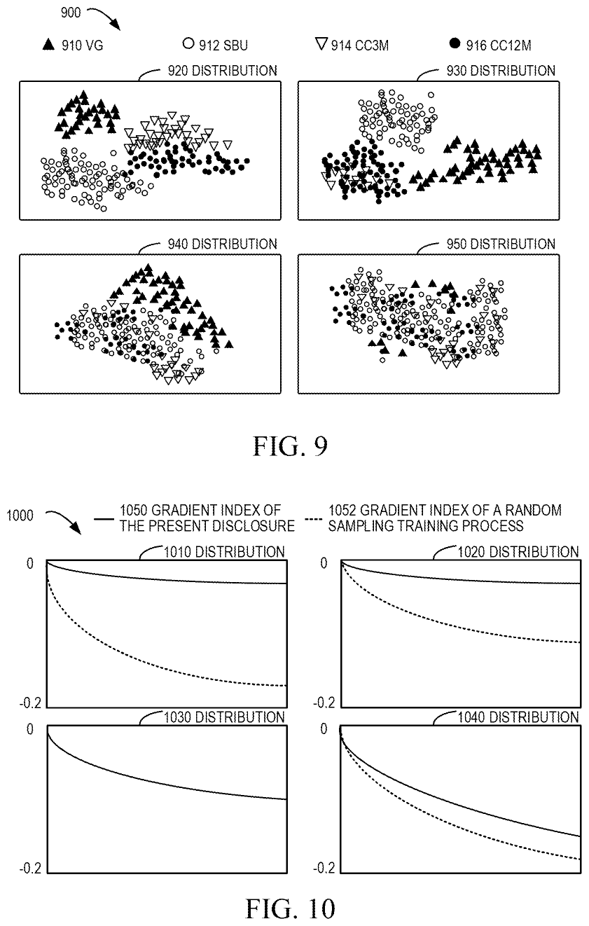

FIG. 9 shows a block diagram 900 of comparisons of feature distribution according to some implementations of the present disclosure. In FIG. 9, a legend 910 represents features of samples of VG, a legend 912 represents features of samples of SBU, a legend 914 represents features of samples of CC3M, and a legend 916 represents features of samples in CC12M. Specifically, distribution 920 represents the distribution of image features output from the contrastive learning model which is obtained by training based on the random sampling process. It will be understood that this feature space may be represented by a high-dimensional (for example, 64-dimensional or other dimensions) vector, and FIG. 9 shows a visual representation of mapping a high-dimensional feature space to a two-dimensional space.

From the distribution 920, it may be seen that the features of VG samples are mainly distributed in the upper left corner of the two-dimensional space, the features of SBU samples are mainly distributed in the lower left corner of the two-dimensional space, the features of CC3M samples are mainly distributed in the upper right corner of the two-dimensional space, and the features of CC12M samples are mainly distributed in the lower right corner of the two-dimensional space. It may be seen that the distribution of features of samples from respective sample sets is not uniform. In other words, the contrastive learning model trained using conventional random sampling processes does not learn the knowledge of respective sample sets sufficiently, which leads to insufficient utilization of respective dimensions of the feature space, resulting in lower accuracy and lower performance of the contrastive learning model. Similarly, distribution 930 represents the distribution of text features output from the contrastive learning model which is obtained by training based on the random sampling process. In the distribution 930, it may be seen that the feature distribution of text from respective sample sets is also uniform.

The lower part of FIG. 9 shows the distribution of features output by the contrastive learning model trained according to the unbiased sampling process of the present disclosure. Specifically, distribution 940 represents the distribution of image features output by the contrastive learning model 410 according to an example implementation of the present disclosure, and distribution 950 represents the distribution of text features output by the contrastive learning model 410 according to an example implementation of the present disclosure. By comparison, it may be seen that the feature distribution of the distribution 940 and 950 according to an example implementation of the present disclosure is more uniform compared to the distribution 920 and 930. In other words, the contrastive learning model 410 obtained by training using the unbiased sampling process 310 may learn the knowledge of respective sample sets sufficiently, and may utilize respective dimensions of the feature space more sufficiently to improve accuracy and performance of the contrastive learning model 410.

Furthermore, the sample set bias will affect optimization performance of the loss function (for example, determined based on an InfoNCE method) in the contrastive learning. Based on the definition of the loss function, a gradient index related to the loss function is affected by the similarity between multiple sample data, and the contribution of negative samples in the contrastive learning process will be weakened due to the sample set bias. Compared to the random sampling process, the proposed unbiased sampling process 310 may increase the number of negative samples in respective batches, thereby obtaining more beneficial effective gradients.

FIG. 10 shows a block diagram 1000 of comparisons of gradients of the loss function according to some implementations of the present disclosure. As shown in FIG. 10, a legend 1050 shows gradient indices according to the unbiased sampling process of the present disclosure, and a legend 1052 shows gradient indices according to the random sampling process of the present disclosure. Furthermore, distribution 1010 shows the gradient indices for the VG sample set, where the vertical axis represents the gradient index (a larger value represents a larger gradient contribution of negative samples) and the horizontal axis represents the sample amount. From the distribution 1010, it can be seen that a better gradient contribution may be achieved using the unbiased sampling process of the present disclosure.

Similarly, distribution 1020, 1030, and 1040 show experimental results for the SBU sample set, the CC3M sample set, and the CC12M sample set, respectively. From FIG. 10, it can be seen that a better gradient index may be obtained for multiple sample sets using the example implementations of the present disclosure. In this way, the contrastive learning model may be trained in a more effective way, thereby improving the accuracy of the contrastive learning model.

It will be understood that although the process of training the contrastive learning model is described above using the image data and the text data as examples of multimodality data. Alternatively, and/or in addition, modalities here may include but are not limited to an image, text, video, audio, and so on. For example, one contrastive learning model may describe the content consistency between images and audio, while a further contrastive learning model may describe the content consistency between video and text, and so on. In this way, contrastive learning technology may be applied in various application environments to obtain the generalized contrastive learning model 410, which is conducive to improve the accuracy of the downstream model.

By utilizing example implementations of the present disclosure, the forgetting problem in the sequential sampling process is avoided as respective sample sets are used uniformly throughout the entire training process. On the other hand, since training samples in each batch are from the same sample set, this may solve the problem of sample set bias in the random sampling process. In this way, the contrastive learning model may be caused to pay more attention to the semantic information of samples in respective sample sets, thereby learning richer semantic knowledge.

Specific details of the training process have been described above. Alternatively, and/or in addition, the aforementioned process may be used to train the contrastive learning model, and then the trained contrastive learning model may be used to process the sample data. For example, sample data to be processed may be input to the trained contrastive learning model, and the trained contrastive learning model may determine the association relationship between data of the sample to be processed based on accurate knowledge obtained in the training stage. For example, in a case that the sample to be processed involves two modalities (for example, text and an image), the trained contrastive learning model may determine whether the two modalities are consistent.

### Sample Process

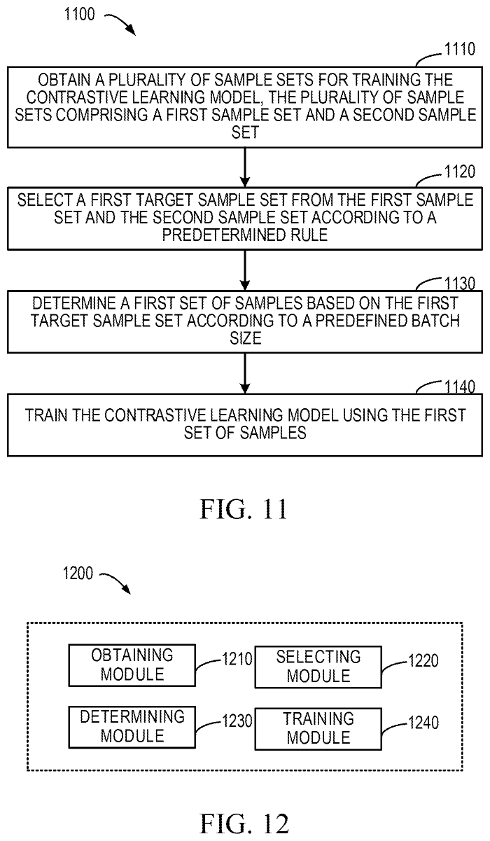

The specific process of determining the update gradient of the contrastive learning model has been described above. A corresponding method will be described in the following with reference to FIG. 11. FIG. 11 shows a flowchart of a method 1100 for training a contrastive learning model according to some implementations of the present disclosure. At block 1110, a plurality of sample sets for training the contrastive learning model are obtained, and the plurality of sample sets comprises a first sample set and a second sample set. At block 1120, a first target sample set is selected from the first sample set and the second sample set according to a predetermined rule. At block 1130, a first set of samples are determined based on the first target sample set according to a predefined batch size. At block 1140, the contrastive learning model is trained using the first set of samples.

According to an example implementation of the present disclosure, the predetermined rule comprises any of: a random selection rule, a polling selection rule, and a selection rule based on a sample amount.

According to an example implementation of the present disclosure, selecting the target sample set according to the selection rule based on a sample amount comprises: determining a first weight for the first sample set and a second weight for the second sample set based on a first sample amount of the first sample set and a second sample amount of the second sample set, respectively; and selecting the target sample set based on the first weight and the second weight.

According to an example implementation of the present disclosure, selecting the target sample set based on the first weight and the second weight comprises: selecting the target sample set from the first sample set and the second sample set based on a distribution function associated with the first weight and the second weight.

According to an example implementation of the present disclosure, a sample in the first sample set and the second sample set comprises: data of a first modality, data of a second modality, and a label representing an association relationship between the data of the first modality and the data of the second modality.

According to an example implementation of the present disclosure, determining the first set of samples from the first target sample set comprises: selecting a positive sample from the first target sample set, a label in the positive sample indicating that there is an association relationship between the data of the first modality and the data of the second modality in the positive sample; and generating a negative sample based on the data of the first modality in the positive sample and the data of the second modality in the first target sample set; and generating the first set of samples based on the positive sample and the negative sample.

According to an example implementation of the present disclosure, generating the negative sample comprises: selecting a further data of the second modality from a data space of the second modality in the first target sample set; and generating the negative sample based on the data of the first modality in the positive sample and further data of the second modality, a label in the negative sample indicating that there is no association relationship between the data of the first modality and the further data of the second modality in the negative sample.

According to an example implementation of the present disclosure, training the contrastive learning model comprises: with respect to the positive sample in the first set of samples, determining, using the contrastive learning model, a first feature for the data of the first modality and a second feature for the data of the second modality in the positive sample, respectively; determining a loss function for the contrastive learning model based on a difference between the first feature and the second feature; and updating the contrastive learning model in a direction for reducing the loss function.

According to an example implementation of the present disclosure, determining the first feature and the second feature comprises: determining, using a first encoder and a second encoder in the contrastive learning model, the first feature and the second feature, respectively, the first encoder describing an association relationship between data of the first modality and a feature for the data of the first modality, and the second encoder describing an association relationship between data of the second modality and a feature for the data of the second modality.

According to an example implementation of the present disclosure, training of the contrastive learning model comprises: with respect to the negative sample in the first set of samples, determining, using the contrastive learning model, a first feature for the data of the first modality and a second feature for the data of the second modality in the negative sample, respectively; determining a loss function of the contrastive learning model based on a difference between the first feature and the second feature; and updating the contrastive learning model in a direction for increasing the loss function.

According to an example implementation of the present disclosure, the first modality comprises any of a plurality of modalities: image, text, video, audio, and the second modality comprises a further one of the plurality of modalities.

According to an example implementation of the present disclosure, the method 1100 further comprises: selecting a second target sample set from the first sample set and the second sample set; determining a second set of samples based on the second target sample set according to a predefined batch size; and training the contrastive learning model using the second set of samples.

According to an example implementation of the present disclosure, determining the second set of samples comprises: selecting a positive sample from unused positive samples in the second set of samples; generating a negative sample based on the positive sample and data of the second modality in the second target sample set; and determining the second set of samples based on the positive sample and negative sample.

According to an example implementation of the present disclosure, selecting the first target sample set is independent of selecting the second target sample set, and the first target sample set is different from the second target sample set.

According to an example implementation of the present disclosure, a method for data processing is provided. The method comprises training the contrastive learning model using the aforementioned method 1100; determining, using the trained contrastive learning model, an association relationship between data in a sample to be processed. SAMPLE APPARATUS AND DEVICE

FIG. 12 shows a block diagram of an apparatus 1200 for training a contrastive learning model according to some implementations of the present disclosure. The apparatus 1200 comprises: an obtaining module 1210, configured to obtain a plurality of sample sets for training the contrastive learning model, the plurality of sample sets comprising a first sample set and a second sample set; a selecting module 1220, configured to select a first target sample set from the first sample set and the second sample set; a determining module 1230, configured to determine a first set of samples based on the first target sample set according to a predefined batch size; and a training module 1240, configured to train the contrastive learning model using the first set of samples.

According to an example implementation of the present disclosure, the predetermined rule comprises any of: a random selection rule, a polling selection rule, and a selection rule based on a sample amount.

According to an example implementation of the present disclosure, the selecting module comprises: a weight determining module, configured to determine a first weight for the first sample set and a second weight for the second sample set based on a first sample amount of the first sample set and a second sample amount of the second sample set, respectively; and a target selecting module, configured to select the target sample set based on the first weight and the second weight.

According to an example implementation of the present disclosure, the target selecting module comprises a distribution selecting module configured to select the target sample set from the first sample set and the second sample set based on a distribution function associated with the first weight and the second weight.

According to an example implementation of the present disclosure, a sample in the first sample set and the second sample set comprises: data of a first modality, data of a second modality, and a label representing an association relationship between the data of the first modality and the data of the second modality.

According to an example implementation of the present disclosure, the determining module 1230 comprises a positive sample selecting module, configured to select a positive sample from the first target sample set, a label in the positive sample indicating that there is an association relationship between the data of the first modality and the data of the second modality in the positive sample; and a negative sample generating module, configured to generate a negative sample based on the data of the first modality in the positive sample and the data of the second modality in the first target sample set; and a generating module, configured to generate the first set of samples based on the positive sample and the negative sample.

According to an example implementation of the present disclosure, the negative sample generating module comprises a data selecting module, configured to select a further data of the second modality from a data space of the second modality in the first target sample set; a combining module, configured to generate the negative sample based on the data of the first modality in the positive sample and further data of the second modality, a label in the negative sample indicating that there is no association relationship between the data of the first modality and the further data of the second modality in the negative sample.

According to an example implementation of the present disclosure, the training module 1240 comprises a feature determining module, configured to, with respect to the positive sample in the first set of samples, determine, using the contrastive learning model, a first feature for the data of the first modality and a second feature for the data of the second modality in the positive sample, respectively; a loss determining module, configured to determine a loss function for the contrastive learning model based on a difference between the first feature and the second feature; and an updating module, configured to update the contrastive learning model in a direction for reducing the loss function.

According to an example implementation of the present disclosure, the feature determining module comprises an encoder module, configured to determine, using a first encoder and a second encoder in the contrastive learning model, the first feature and the second feature, respectively, the first encoder describing an association relationship between data of the first modality and a feature for the data of the first modality, and the second encoder describing an association relationship between data of the second modality and a feature for the data of the second modality.

According to an example implementation of the present disclosure, the feature determining module is further configured to, with respect to the negative sample in the first set of samples, determine, using the contrastive learning model, a first feature for the data of the first modality and a second feature for the data of the second modality in the negative sample, respectively; the loss determining module, configured to determine a loss function of the contrastive learning model based on a difference between the first feature and the second feature; and the updating module, configured to update the contrastive learning model in a direction for increasing the loss function.

According to an example implementation of the present disclosure, the first modality comprises any of a plurality of modalities: image, text, video, audio, and the second modality comprises a further one of the plurality of modalities.

According to an example implementation of the present disclosure, the selecting module 1220 is further configured to select a second target sample set from the first sample set and the second sample set; the determining module is further configured to determine a second set of samples based on the second target sample set according to a predefined batch size; and the training module is further configured to train the contrastive learning model using the second set of samples.

According to an example implementation of the present disclosure, the positive sample selecting module is further configured to select a positive sample from unused positive samples in the second set of samples; the negative sample generating module is further configured to generate a negative sample based on the positive sample and data of the second modality in the second target sample set; and the combining module is further configured to determine the second set of samples based on the positive sample and negative sample.

According to an example implementation of the present disclosure, the selecting module 1220 is further configured to select the first target sample set and the second target sample set in an independent manner, and the first target sample set is different from the second target sample set.

According to an example implementation of the present disclosure, an apparatus for training a contrastive learning model is provided. The apparatus comprises a training module, configured to train the contrastive learning model using the aforementioned apparatus 1200; and a determining module, configured to determine, using the trained contrastive learning model, an association relationship between data in a sample to be processed.

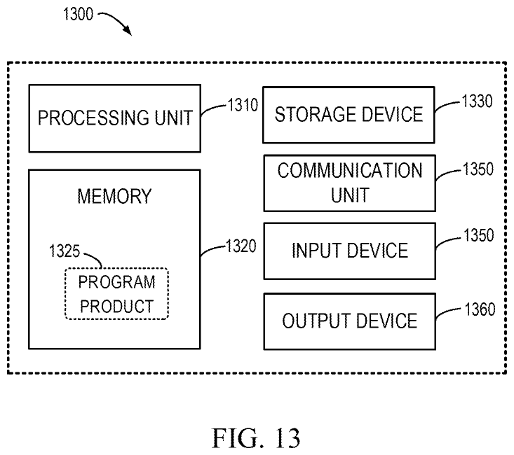

FIG. 13 illustrates a block diagram of an electronic device 1300 in which one or more implementations of the present disclosure may be implemented. It would be appreciated that the electronic device 1300 shown in FIG. 13 is only an example and should not constitute any restriction on the function and scope of the implementations described herein.

As shown in FIG. 13, the electronic device 1300 is in the form of a general computing device. The components of the electronic device 1300 may include, but are not limited to, one or more processors or processing units 1310, a memory 1320, a storage device 1330, one or more communication units 1340, one or more input devices 1350, and one or more output devices 1360. The processing unit 1310 may be an actual or virtual processor and may execute various processes according to the programs stored in the memory 1320. In a multiprocessor system, multiple processing units execute computer executable instructions in parallel to improve the parallel processing capability of the electronic device 1300.

The electronic device 1300 typically includes a variety of computer storage medium. Such medium may be any available medium that is accessible to the electronic device 1300, including but not limited to volatile and non-volatile medium, removable and non-removable medium. The memory 1320 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 1330 may be any removable or non-removable medium, and may include a machine-readable medium, such as a flash drive, a disk, or any other medium, which may be used to store information and/or data (such as training data for training) and may be accessed within the electronic device 1300.

The electronic device 1300 may further include additional removable/non-removable, volatile/non-volatile storage medium. Although not shown in FIG. 13, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 1320 may include a computer program product 1325, which has one or more program modules configured to perform various methods or acts of various implementations of the present disclosure.

The communication unit 1340 communicates with a further computing device through the communication medium. In addition, functions of components in the electronic device 1300 may be implemented by a single computing cluster or multiple computing machines, which may communicate through a communication connection. Therefore, the electronic device 1300 may be operated in a networking environment using a logical connection with one or more other servers, a network personal computer (PC), or another network node.

The input device 1350 may be one or more input devices, such as a mouse, a keyboard, a trackball, etc. The output device 1360 may be one or more output devices, such as a display, a speaker, a printer, etc. The electronic device 1300 may also communicate with one or more external devices (not shown) through the communication unit 1340 as required. The external device, such as a storage device, a display device, etc., communicate with one or more devices that enable users to interact with the electronic device 1300, or communicate with any device (for example, a network card, a modem, etc.) that makes the electronic device 1300 communicate with one or more other computing devices. Such communication may be executed via an input/output (I/O) interface (not shown).

According to example implementation of the present disclosure, a computer-readable storage medium is provided, on which a computer-executable instruction or computer program is stored, wherein the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the apparatus, the device and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps may be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a section of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes may also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is exemplary, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various implementations disclosed herein.

I/we claim:

1. A method for training a contrastive learning model, comprising:
obtaining a plurality of sample sets for training the contrastive learning model, the plurality of sample sets comprising a first sample set and a second sample set;
selecting a first target sample set from the first sample set and the second sample set according to a predetermined rule;
determining a first set of samples based on the first target sample set according to a predefined batch size; and
training the contrastive learning model using the first set of samples.

2. The method according to claim 1, wherein the predetermined rule comprises any of:
a random selection rule, a polling selection rule, and a selection rule based on a sample amount.

3. The method according to claim 1, wherein selecting the target sample set according to the selection rule based on a sample amount comprises:
determining a first weight for the first sample set and a second weight for the second sample set based on a first sample amount of the first sample set and a second sample amount of the second sample set, respectively; and
selecting the target sample set based on the first weight and the second weight.

4. The method according to claim 3, wherein selecting the target sample set based on the first weight and the second weight comprises: selecting the target sample set from the first sample set and the second sample set based on a distribution function associated with the first weight and the second weight.

5. The method according to claim 1, wherein a sample in the first sample set and the second sample set comprises: data of a first modality, data of a second modality, and a label representing an association relationship between the data of the first modality and the data of the second modality.

6. The method according to claim 5, wherein determining the first set of samples from the first target sample set comprises:
selecting a positive sample from the first target sample set, a label in the positive sample indicating that there is an association relationship between the data of the first modality and the data of the second modality in the positive sample; and
generating a negative sample based on the data of the first modality in the positive sample and the data of the second modality in the first target sample set; and
generating the first set of samples based on the positive sample and the negative sample.

7. The method according to claim 6, wherein generating the negative sample comprises:
selecting a further data of the second modality from a data space of the second modality in the first target sample set; and
generating the negative sample based on the data of the first modality in the positive sample and further data of the second modality, a label in the negative sample indicating that there is no association relationship between the data of the first modality and the further data of the second modality in the negative sample.

8. The method according to claim 6, wherein training the contrastive learning model comprises: with respect to the positive sample in the first set of samples,
determining, using the contrastive learning model, a first feature for the data of the first modality and a second feature for the data of the second modality in the positive sample, respectively;
determining a loss function for the contrastive learning model based on a difference between the first feature and the second feature; and
updating the contrastive learning model in a direction for reducing the loss function.

9. The method according to claim 8, wherein determining the first feature and the second feature comprises: determining, using a first encoder and a second encoder in the contrastive learning model, the first feature and the second feature, respectively, the first encoder describing an association relationship between data of the first modality and a feature for the data of the first modality, and the second encoder describing an association relationship between data of the second modality and a feature for the data of the second modality.

10. The method according to claim 6, wherein training of the contrastive learning model comprises: with respect to the negative sample in the first set of samples, determining, using the contrastive learning model, a first feature for the data of the first modality and a second feature for the data of the second modality in the negative sample, respectively;
determining a loss function of the contrastive learning model based on a difference between the first feature and the second feature; and
updating the contrastive learning model in a direction for increasing the loss function.

11. The method according to claim 5, wherein the first modality comprises any of a plurality of modalities: image, text, video, audio, and the second modality comprises a further one of the plurality of modalities.

12. The method according to claim 5, further comprising:
selecting a second target sample set from the first sample set and the second sample set;
determining a second set of samples based on the second target sample set according to a predefined batch size; and
training the contrastive learning model using the second set of samples.

13. The method according to claim 12, wherein determining the second set of samples comprises:
selecting a positive sample from unused positive samples in the second set of samples;
generating a negative sample based on the positive sample and data of the second modality in the second target sample set; and
determining the second set of samples based on the positive sample and negative sample.

14. The method according to claim 12, wherein selecting the first target sample set is independent of selecting the second target sample set, and the first target sample set is different from the second target sample set.

15. The method according to claim 1, further comprising: determining an association relationship between data in a sample that is to be processed using the trained contrastive learning model.

16. An electronic device, comprising:
at least one processing unit; and
at least one memory coupled to the at least one processing unit and storing instruction s to be executed by the at least one processing unit, the instructions, when executed by the at least one processing unit, causing the device to perform a method, the method comprising:
obtaining a plurality of sample sets for training the contrastive learning model, the plurality of sample sets comprising a first sample set and a second sample set;
selecting a first target sample set from the first sample set and the second sample set according to a predetermined rule;
determining a first set of samples based on the first target sample set according to a predefined batch size; and
training the contrastive learning model using the first set of samples.

17. The electronic device of claim 16, wherein the predetermined rule comprises any of: a random selection rule, a polling selection rule, and a selection rule based on a sample amount.

18. The electronic device of claim 16, wherein selecting the target sample set according to the selection rule based on a sample amount comprises:
determining a first weight for the first sample set and a second weight for the second sample set based on a first sample amount of the first sample set and a second sample amount of the second sample set, respectively; and
selecting the target sample set based on the first weight and the second weight.

19. The electronic device of claim 16, wherein the method further comprises: determining an association relationship between data in a sample that is to be processed using the trained contrastive learning model.

20. A non-transient computer-readable storage medium storing a computer program thereon, the computer program, when executed by a processor, performing a method, the method comprising:
obtaining a plurality of sample sets for training the contrastive learning model, the plurality of sample sets comprising a first sample set and a second sample set;
selecting a first target sample set from the first sample set and the second sample set according to a predetermined rule;
determining a first set of samples based on the first target sample set according to a predefined batch size; and
training the contrastive learning model using the first set of samples.
